(19) United States
(12) Patent Application Publication
(10) Pub. No.: US 2013/0124701 A1
(43) Pub. Date: May 16, 2013

(54) METHOD, ARRANGEMENT AND PROGRAM FOR EFFICIENT CONFIGURATION OF NETWORK NODES

(71) Applicants: Axel Klatt, Koeln (DE); Juergen Maurer, Bad Neuenahr/Ahrweiler (DE)

(72) Inventors: Axel Klatt, Koeln (DE); Juergen Maurer, Bad Neuenahr/Ahrweiler (DE)

(73) Assignee: DEUTSCHE TELEKOM AG, Bonn (DE)

(21) Appl. No.: 13/812,142

(22) PCT Filed: Jul. 27, 2011
(86) PCT No.: PCT/EP11/03757

§ 371 Date: Jan. 25, 2013

Related U.S. Application Data
(60) Provisional application No. 61/368,333, filed on Jul. 28, 2010.

(30) Foreign Application Priority Data
Jul. 28, 2010 (EP) 10 007 845.0

(51) Int. Cl. G06F 15/177

(52) U.S. Cl. CPC G06F 15/177
USPC 709/220

(57) ABSTRACT

A method for configuration of a plurality of network nodes for use with a network includes: for each network node of the plurality of network nodes in a first step, assigning, by the network, a preliminary Internet Protocol link to the network node; in a second step, transmitting, by the network, preliminary configuration parameters to the network node; and in a third step, using, by the network node, the preliminary configuration parameters to retrieve, by using a standardized naming convention in a request to the configuration server entity, additional configuration information, wherein the additional configuration information comprises at least one of a vendor- or technology-specific commissioning file.

### CROSS-REFERENCE TO RELATED APPLICATIONS

This application is a U.S. National Phase application under 35 U.S.C. §371 of International Application No. PCT/EP2011/003757, filed on Jul. 27, 2011, and claims benefit to U.S. Provisional Application No. 61/368,333, filed on Jul. 28, 2010, and to European Patent Application No. EP 10007845.0, filed on Jul. 28, 2010. The International Application was published in English on February 2, 2012 as WO 2012/013338 A1 under PCT Article 21(2).

### FIELD

The present invention relates to a method, an arrangement and a program for efficient configuration of network nodes. It enables the efficient configuration of network nodes which require a specific configuration and is preferably useable in a multitude of network nodes, for example but not limited to any cellular mobile network like, GERAN, UTRAN, LTE/E-UTRAN, LTE-Advanced, cdma2000, WiMAX, WiBro etc.

### BACKGROUND

As described for example in, “NGMN Use Cases related to Self Organising Network, Overall Description”, A Deliverable by the NGMN Alliance (Release Date: May 31, 2007), in Self Organizing Networks (SON) is a Plug and Play (PnP) feature which provides the functionality to deploy Internet Protocol (IP) based radio nodes (such as for example eNodeBs of an E-UTRAN network) into the network without any pre-configuration of the node itself This means that typically such radio nodes do not have a specific pre-configuration configured unless they should be put in operation.

Typically such kind of nodes use a Dynamic Host Configuration Protocol (DHCP) protocol to request a temporary IP address to establish a basic communication with entities in the network which can download the configuration to be used by the node for regular operation.

In addition to the basic means for communication additional temporary transport parameters like Internet Protocol (IP) addresses of the Internet Protocol Security (IPsec) GateWay, the Public Key Infrastructure Server (PKI server) and the Network Management System (NMS) are typically required.

In the worst case a multitude of different configuration servers are required to configure specific nodes inside a network.

The disadvantage of the current situation is that distinguishing between different vendors and/or technologies during the DHCP process is adding complexity to the DHCP server function as well as to routing of the traffic through a security enabled operator backbone. Not all commercially available DHCP servers would support such a complex functionality. In any way this method currently used is inefficient and cost intensive.

A further disadvantage of the current state of the art is the fact that to enable the usage of the SON PnP functionality for radio nodes of different vendors and/or technologies within the same transport network, it has to be distinguished during the DHCP process between the vendors and technologies. The main reason for that is:
the SON PnP DHCP response is not standardized; and
each vendor/technology is using their own NMS for SON PnP.

### SUMMARY

In an embodiment, the present invention provides a method for configuration of a plurality of network nodes for use with a network, wherein the configuration of the plurality of network nodes enables the network nodes to function as a part of the network, the network having a configuration server entity, the configuration server entity including at least one of vendor- or technology-specific commissioning files according to a standardized naming convention for the plurality of network nodes, the method including: for each network node of the plurality of network nodes: in a first step, assigning, by the network, a preliminary Internet Protocol link to the network node; in a second step, transmitting, by the network, preliminary configuration parameters to the network node; and in a third step, using, by the network node, the preliminary configuration parameters to retrieve, by using the standardized naming convention in a request to the configuration server entity, additional configuration information, wherein the additional configuration information comprises at least one of a vendor- or technology-specific commissioning file. The standardized naming convention is also used in an involved Network Management System specific to at least one of a vendor or a technology. The Network Management System exports at least one of respective vendor- or respective technology-specific commissioning files to the configuration server entity using the standardized naming convention.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 schematically illustrates a cellular public land mobile network (PLMN) comprising a plurality of radio cells, wherein further network nodes are associated to the public land mobile network (PLMN).

### DETAILED DESCRIPTION

Embodiments of the present invention simplify the configuration of network nodes (to be integrated into an existing public land mobile network (PLMN)) in an efficient and cost effective manner, especially in case that a multitude of different network nodes are used (wherein each of these different network nodes to be added (e.g. to a public land mobile network (PLMN)) and to be configured requires a specific communication to a specific configuration server) to enable better resource utilization, reduced costs and higher efficiency.

In an embodiment, the present invention provides a method for the configuration of a plurality of network nodes for use with a network, especially a public land mobile network (PLMN), wherein the configuration of the plurality of network nodes enables the plurality of network nodes to function as a part of the network, the network having a configuration server entity, wherein the configuration server entity comprises, for the plurality of network nodes, all vendor and/or technology specific commissioning files according to a standardized naming convention,
wherein the plurality of network nodes are enabled to use the naming convention,
wherein the naming convention is also used in an involved Network Management System being specific to a vendor and/or a technology,
wherein the vendor and/or technology specific Network Management System exports the respective vendor and/or technology specific commissioning files to the configuration server entity using the naming convention,
wherein for each network node of the plurality of network nodes the method comprises the following steps:
in a first step, the network assigns a preliminary Internet Protocol link to the network node,
in a second step, the network transmits preliminary configuration parameters to the network node,
in a third step, the network node uses the preliminary configuration parameters to retrieve, by using the naming convention in a request to the configuration server entity, additional configuration information from the configuration server entity within the network, wherein the additional configuration information comprises the vendor and/or technology specific commissioning files.

In an embodiment, the present invention provides a method for the configuration of a network node for use with a public land mobile network (PLMN), wherein the configuration of the network node enables the network node to function as a part of the public land mobile network (PLMN), the public land mobile network (PLMN) having a configuration server entity, wherein
in a first step, the public land mobile network (PLMN) assigns a preliminary Internet Protocol link to the network node,
in a second step, the public land mobile network (PLMN) transmits preliminary configuration parameters to the network node,
in a third step, the network node uses the preliminary configuration parameters to retrieve additional configuration information from the configuration server entity within the public land mobile network (PLMN).

In the context of the present invention, the addition of further network nodes (self-organizing network nodes) to an existing network is especially described with respect to a public land mobile network (PLMN) but the application to any other type of Internet Protocol network is also possible with regard to the present invention.

According to the present invention, it is advantageously possible for the network node to be configured—e.g. the radio node in a cellular mobile system—to perform the following tasks within the second step of the inventive method (by using temporary transport (or configuration) parameters received from DHCP during the first step of the inventive method):
retrieve an operator certificate
establish an IPsec tunnel
request the final configuration from the configuration server entity.

In order to finalize the installation or configuration process, the node—for example a radio node—having received the additional (or final) configuration, will release the temporary IP address and restart operation with the final configuration.

In contrast to the current state of the art, the SON PnP functionality can be simplified significantly by usage of a common configuration server (or configuration server entity) in the operator's network (i.e. especially in the public land mobile network (PLMN)) to which all of the plurality of (radio) network nodes to be configured connect, regardless of the vendor or technology. This is in contrast to the need for a multitude of different configuration servers required according to the prior art (which implies a more cumbersome and more expensive configuration of a multitude of network nodes).

According to the present invention, it is preferred to use the Dynamic Host Configuration Protocol (DHCP) in the first step.

Furthermore, it is preferred according to the present invention that a standardized DHCP response is used in the first step, wherein the standardized DHCP response preferably comprises a defined structure to be used by all involved network nodes for which configuration is required. According to another preferred embodiment of the present invention, the standardized DHCP response comprises a defined structure which uses DHCP option codes.

Thereby, it is advantageously possible to use the DHCP protocol for an efficient exchange of configuration information during the establishment of a communication channel between the network node (to be newly associated with the public land mobile network (PLMN) and which needs configuration) and the network, especially a public land mobile network (PLMN). In the context of the present invention, the use of a standardized DHCP response is very advantageous because it is possible to reduce the complexity in the deployment and configuration process of new network nodes (especially radio nodes of a public land mobile network) using a heterogeneous structure, i.e. the network nodes are of different vendors and/or use different technologies (in the case of radio nodes of a public land mobile network: especially different radio access technologies (RAT)) which implies that different (final) configuration parameters are needed.

For example, using the naming convention enables the plurality of network nodes to access the precise configuration information or configuration files from a common server (the configuration server entity). For example, by means of using the naming convention, it is possible to use a string, e.g. of the form “[vendor]_[technology]_[node-ID]”, to indicate the path to access the configuration files of a specific network node (especially radio node of a public land mobile network) of the vendor “vendor”, using the technology “technology”, and having the (vendor specific) node-ID (or (vendor specific) serial number) “node-ID”. By using such a naming convention as a means to convey an information regarding a path to access configuration files, it is advantageously possible according to the present invention that heterogeneous network structures can be administrated more easily.

According to a further preferred embodiment of the present invention, the standardized DHCP response consists of a defined structure which uses DHCP option codes and a multitude of defined sub-option codes, wherein it is especially preferred that a first sub-option code comprises the IPsec Gateway node address of the public land mobile network (PLMN), wherein a second sub-option code comprises the Public Key Infrastructure (PKI) node address of the public land mobile network (PLMN), wherein a third sub-option code comprises the subject name for Certificate Authority (CA) server, and wherein a fourth sub-option code comprises the configuration server address. Similar to the above, further sub-option codes can be added in an alternative embodiment of the standardized usage of the DHCP response.

Thereby, it is also advantageously possible to use the sub-options feature of the DHCP protocol for an efficient exchange of temporary configuration information (preliminary configuration information).

According to the present invention, the configuration server entity comprises all vendor and/or technology specific commissioning files.

Thereby, it is advantageously possible according to the present invention to need to establish communication link to the configuration server entity only in order to retrieve the additional configuration information (required for completing the configuration process of the network node), regardless of the type of the network node, i.e. regardless of the vendor or manufacturer of the network node.

The present invention further relates to a configuration server entity within a public land mobile network (PLMN), wherein at least one network node is to be configured and connected to the public land mobile network (PLMN) by performing an inventive method, wherein the configuration server entity comprises all vendor specific and/or technology specific commissioning files for configuring the at least one network node.

According to the present invention, it is preferred that such a configuration server entity or configuration server is located either as a standalone unit within the public land mobile network (PLMN) or the configuration server functionality is integrated in an existing unit or node of the public land mobile network (PLMN).

It is furthermore preferred according to the present invention, that a standardized definition of a naming convention for the commissioning files is used. Still more preferably, such a standardized definition of a naming convention for the commissioning files consists of a first identifier and one or multiple subsequent identifiers which are defined in an unambiguous way for all network nodes in the public land mobile network (PLMN).

Furthermore, it is also preferred that the naming convention is implemented or configured to any of the involved network nodes.

According to a further preferred embodiment of the present invention, the naming convention as specified above is implemented or configured to any radio node in the public land mobile network (PLMN), especially a cellular network.

According to a further preferred embodiment of the present invention, the naming convention is provided to the involved Network Management System (NMS).

The invention furthermore relates to a network node to be connected to and operatively used with a public land mobile network (PLMN), wherein the network node is to be configured and connected to the public land mobile network (PLMN) by performing an inventive method, wherein the network node is configured such that a standardised DHCP response is used in the first step.

Additionally, the present invention relates to a program comprising a computer readable program code for executing an inventive method or for configuring or controlling an inventive network node or an inventive configuration server entity.

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn on scale for illustrative purposes.

Furthermore, the terms first, second, third and the like in the description and in the claims are used for distinguishing between similar elements and not necessarily for describing a sequential or chronological order. It is to be understood that the terms so used are interchangeable under appropriate circumstances and that the embodiments of the invention described herein are capable of operation in other sequences than described of illustrated herein.

In this section, the method is described for illustration using a cellular mobile network according to the E-UTRAN standards exemplarily. The method is in no way limited to this example and can preferably be used for configuration of network nodes using any technology, not even specifically for cellular mobile networks only.

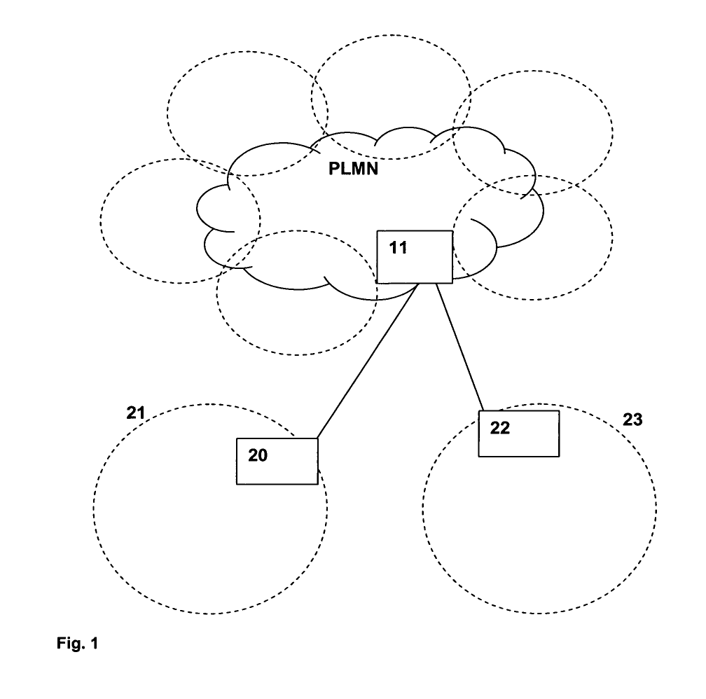

In FIG. 1, a cellular public land mobile network (PLMN) is schematically represented comprising a plurality of radio cells. The public land mobile network (PLMN) is to be extended or enhanced by means of further network nodes, designated by reference signs 20 and 22. The further network nodes 20, 22 are hereinafter also called a first network node 20 and a second network node 22. The further network nodes 20, 22 initially do not belong to the public land mobile network (PLMN) but are to be integrated within the public land mobile network (PLMN) in the manner of self-organizing network devices (hereinafter also called SON devices or SON nodes). After the association of the further network nodes 20, 22 to the public land mobile network (PLMN), such network nodes 20, 22 function, e.g., as base stations providing radio coverage areas (“radio cell”) such as a first radio cell 21 of the first network node 20, and a second radio cell 23 of the second network node 22.

The use of such network nodes 20, 22 to be associated to an existing public land mobile network (PLMN) often requires using different network nodes 20, 22, i.e. such network nodes being provided by different manufacturers and/or by different vendors.

According to the present invention, it is possible to use such a multitude of different network nodes 20, 22 with an existing public land mobile network (PLMN) in a simplified manner, namely by means of using a centralized configuration server entity 11 comprising different configuration information required for the use of different models of network nodes 20, 22. Such configuration information is often stored by means of commissioning files, such as vendor specific commissioning files and/or technology specific commissioning files.

In order to allow the usage of a single centralized server (or configuration server entity 11), it is proposed to apply an optimized method for the configuration of the network nodes 20, 22 with the advantages of a less complicated and hence less costly configuration process as described in the following.

The proposed inventive method for the configuration of network nodes 20, 22 can be illustrated as follows:
usage of a single standardized DHCP response (in the second step according to the inventive method), comprising for example of the following structure:
   (e.g. option code 43:
   suboption 1: IPsec Gateway address,
   suboption 2: Public Key Infrastructure (PKI) address,
   suboption 3: subject name for CA server,
   suboption 4: configuration server address,
   . . . )
establishing the usage of the configuration server entity (centralized configuration server), which stores all vendor/technology specific commissioning files
preferably using a standardized definition regarding the naming convention for the commissioning files such as e.g. [vendor]_[technology]_[node-ID].

It is preferred according to the present invention
that the naming convention is implemented or configured with respect to any of the involved network nodes 20, 22 (i.e. the radio nodes in a cellular network), and furthermore
that the naming convention is provided to the involved Network Management System (NMS)

Further steps of the proposed method include:
the vendor/technology specific NMS exports their commissioning files to the configuration server entity 11 using the naming convention mentioned above;
the network nodes 20, 22 download their specific commissioning file from the configuration server via for example SSH File Transfer Protocol (SFTP) or File Transfer Protocol (FTP) using the naming convention mentioned above.

By using the proposed method it is advantageously possible to use a central configuration server (or configuration server entity) 11 where configuration files of a multitude of network management systems are locally stored instead of a distributed storage on multiple network management systems.

With such an approach it is advantageously possible to also distribute the traffic for configuration from network management systems to the (possibly higher performance) configuration server entity 11 and thus simplify the network management systems.

This is especially beneficial for networks where a huge numbers of network nodes 20, 22 require configuration data to be retrieved quite often (which would not be possible with the huge number of requests towards a standard network management system).

Further advantages by using the proposed method are that simple DHCP servers can be used instead of complex and expensive ones achieving a significant cost reduction for the network operator due to reduced complexity and due to reduces configuration effort.

Even further only a single path through a security enabled operator backbone has to be opened for SON (self-organized networks) PnP (plug and play) devices to improve the security of the network.

Additionally, the situation of faults or errors of the network node 20, 22 can be advantageously solved by using the inventive method as a network node 20 (which for any reason) that lost the configuration necessary for normal operation only needs to contact the central configuration server and download the initial configuration file again, similar to the original or initial process for putting this network node 20 in operation.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B.” Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise.

1-13. (canceled)

14. A method for configuration of a plurality of network nodes for use with a network, wherein the configuration of the plurality of network nodes enables the network nodes to function as a part of the network, the network having a configuration server entity, the configuration server entity comprising at least one of vendor- or technology-specific commissioning files according to a standardized naming convention for the plurality of network nodes, the method comprising;
for each network node of the plurality of network nodes:
in a first step, assigning, by the network, a preliminary Internet Protocol link to the network node;
in a second step, transmitting, by the network, preliminary configuration parameters to the network node; and
in a third step, using, by the network node, the preliminary configuration parameters to retrieve, by using the standardized naming convention in a request to the configuration server entity, additional configuration information, wherein the additional configuration information comprises at least one of a vendor- or technology-specific commissioning file;
wherein the standardized naming convention is also used in an involved Network Management System specific to at least one of a vendor or a technology; and
wherein the Network Management System exports at least one of respective vendor- or respective technology-specific commissioning files to the configuration server entity using the standardized naming convention.

15. The method according to claim 14, wherein the network is a Public Land Mobile Network (PLMN),

16. The method according to claim 14, wherein Dynamic Host Configuration Protocol (DHCP) is used in the first step.

17. The method according to claim 16, wherein a standardized DHCP response is used in the first step.

18. The method according to claim 17, wherein the standardized DHCP response comprises a defined structure to be used by all involved network nodes for which configuration is required.

19. The method according to claim 17, wherein the standardized DHCP response comprises a defined structure which uses DHCP option codes.

20. The method according to claim 17, wherein the standardized DHCP response comprises a defined structure which uses DHCP option codes and a multitude of defined sub-option codes.

21. The method according to claim 20, wherein a first sub-option code comprises the IPsec Gateway node address of the network, wherein a second sub-option code comprises the Public Key Infrastructure (PKI) node address of the network, wherein a third sub-option code comprises the subject name for a Certificate Authority (CA) server, and wherein a fourth sub-option code comprises the configuration server address.

22. The method according to claim 14, wherein in case of an error occurrence during operation and after the initial configuration of a network node, the network node is reconfigured by performing the first, second and third steps.

23. A configuration server entity within a network, comprising:
at least one of vendor- or technology-specific commissioning files according to a standardized naming convention for configuring a plurality of network nodes to function as part of a network;
wherein each node of the plurality of network nodes is configurable by performing the following steps:
in a first step, assigning, by the network, a preliminary Internet Protocol link to the network node;
in a second step, transmitting, by the network, preliminary configuration parameters to the network node; and
in a third step, using, by the network node, the preliminary configuration parameters to retrieve, by using the standardized naming convention in a request to the configuration server entity, additional configuration information, wherein the additional configuration information comprises at least one of a vendor- or technology-specific commissioning file;
wherein the standardized naming convention is also used in an involved Network Management System specific to at least one of a vendor or a technology; and
wherein the Network Management System is configured to export at least one of respective vendor- or respective technology-specific commissioning files to the configuration server entity using the standardized naming convention.

24. One or more non-transitory computer-readable media having processor-executable instructions stored thereon for configuration of a plurality of network nodes for use with a network, wherein the configuration of the plurality of network nodes enables the network nodes to function as a part of the network, the network having a configuration server entity, the configuration server entity comprising at least one of vendor- or technology-specific commissioning files according to a standardized naming convention for the plurality of network nodes, the processor-executable instructions, when executed by a processor, causing the following steps to be performed:
for each network node of the plurality of network nodes:
in a first step, assigning, by the network, a preliminary Internet Protocol link to the network node;
in a second step, transmitting, by the network, preliminary configuration parameters to the network node; and
in a third step, using, by the network node, the preliminary configuration parameters to retrieve, by using the standardized naming convention in a request to the configuration server entity, additional configuration information, wherein the additional configuration information comprises at least one of a vendor- or technology-specific commissioning file;
wherein the standardized naming convention is also used in an involved Network Management System specific to at least one of a vendor or a technology; and
wherein the Network Management System exports at least one of respective vendor or respective technology-specific commissioning files to the configuration server entity using the standardized naming convention.
